(19) United States
(12) Patent Application Publication
(10) Pub. No.: US 2011/0300766 A1
(43) Pub. Date: Dec. 8, 2011

(54) Silicone Gel Seal And Method For Its Preparation And Use

(76) Inventors: Lawrence Carbary, Midland, MI (US); Agnes Jaszenovics, Newark, CA (US); Husni Mahmoud, Fremont, CA (US); Felix Oseguera, Newark, CA (US)

(21) Appl. No.: 13/202,061

(22) PCT Filed: Feb. 17, 2010
(86) PCT No.: PCT/US10/24365

§ 371 Date: Aug. 17, 2011

Related U.S. Application Data
(60) Provisional application No. 61/153,097, filed on Feb. 17, 2009.

(51) Int. Cl. B32B 17/10; B32B 7/04; B32B 5/18; B32B 37/12; B32B 27/04

(52) U.S. Cl. 442/1; 156/325; 156/329; 428/448; 428/447; 428/304.4; 428/339

(57) ABSTRACT

A form stable gel may be used to make a seal between substrates to minimize air and moisture penetration. The form stable gel is useful in construction industry applications such as sealing window frame members, sealing retrofit and replacement windows, as well as indoor applications such as sealing bathtubs, sinks and shower surrounds. The form stable gel is also useful for sealing applications in boat hulls.

### CROSS-REFERENCE TO RELATED APPLICATIONS

None.

### STATEMENT REGARDING FEDERALLY FUNDED RESEARCH AND DEVELOPMENT

None.

### BACKGROUND OF THE INVENTION

1. Technical Field

A silicone gel (‘gel’) is used to seal substrates against gases (such as air) and vapor (such as moisture) penetration. The gel is fabricated to be form stable and has sufficient tack to adhere when applied to a first substrate until a second substrate is fastened thereto. The gel is useful in construction applications such as window framing and flashing, as well as indoor sealing applications, such as sealing at the perimeter of bathtubs, shower enclosures, and sinks The gel is useful in marine applications such as sealing windows and/or through holes in boat hulls.

2. Background

Various products and methods are known in the art for sealing framing members to minimize gas and vapor penetration. Wet sealant has been used in the past. However, wet sealant suffers from the drawback of being messy to apply. Furthermore, in framing applications, the sealant may be applied and then compressed between framing members. During this compression, the excess is squeezed out and must be wiped off and discarded. Furthermore, volatile organic compounds (VOCs) may be released into the atmosphere during curing of the wet sealant.

Alternatively, a sheet of silicone rubber or foam may be cut and then the resulting piece may be placed between the framing members and compressed when the members are fastened together. This method eliminates the VOC emissions because the silicone rubber is cured before application to the substrates. However, silicone rubber may suffer from the drawback of lacking sufficient tack (self adhesion) to stay on the first substrate during the fastening process when, for example, the silicone rubber is placed against a substrate vertically.

A sheet or tape of silicone foam with adhesive on its sides has also been proposed. However, this product suffers from the drawback that it cannot be trimmed once applied to the substrate. If trimmed, the foam can delaminate from the adhesive, leaving an adhesive residue or film on the substrate, which can cause dirt pick up and poor appearance.

There is a continuing need in the construction industry to produce products with better aesthetics, reduced waste, and reduced VOC emissions.

### BRIEF SUMMARY OF THE INVENTION

A method for forming a gas and vapor resistant seal between substrates is disclosed. The method comprises:
i) applying a form stable gel to a first substrate, and
ii) connecting the first substrate and a second substrate;
   thereby forming a seal between the first substrate and the second substrate.

### BRIEF DESCRIPTION OF THE DRAWINGS

FIG. 1 is an example of a form stable gel with release liners on its surfaces.

FIG. 2 is a process flow diagram for making the form stable gel.

FIG. 3 shows photographs of a method for using the form stable gel to seal an aluminum frame.

FIG. 4 shows photographs of an additional method step for the method of FIG. 3.

### REFERENCE NUMERALS

100 Form Stable Gel
101 Support
102 Layer of Gel
103 Release Liner
201 Fiberglass Mesh Payoff
202 Primary Coater
203 Drum of Base
204 Drum of Curing Agent
205 Drum Pumps
206 Static Mixer
207 Mixer
208 Storage Tank
209 Fiberglass Mesh
210 Primary Heater
211 Form Stable Gel
212 Release Liner Feed Roll
213 Product Take Up

### DETAILED DESCRIPTION OF THE INVENTION

All amounts, ratios, and percentages are by weight, unless otherwise indicated. The articles ‘a’, ‘an’, and ‘the’ each refer to one or more, unless otherwise indicated. All viscosity measurements were taken at 25° C. unless otherwise stated.

### Gel

The curable silicone composition used in the method described above cures to form a gel that is form stable. The curing mechanism of the curable silicone composition may be any cure mechanism that does not release by products that foul the substrates between which the gel is interposed. For example, the curable silicone composition may be addition reaction curable such as a thermally curable one part composition or a two part composition that cures at ambient or elevated temperature, a peroxide curable silicone composition, a radiation curable silicone composition, or a combination thereof.

The gel used in the method and article described herein is form stable. For purposes of this application, the term ‘gel’ means a lightly crosslinked polymer network. A gel has a hardness value lower than hardness typically associated with a silicone rubber, which has a higher crosslink density than a gel. The gel may have a hardness ranging from 30 to 70 on a Shore 00 scale as measured according to ASTM Standard D 2240-05 using a durometer. Alternatively, the gel may have a hardness ranging from 50 grams to 300 grams, alternatively 100 grams to 200 grams, as measured by the method of reference example 2. These methods permit hardness measurements based on indentation.

For purposes of this application, ‘form stable’ means that when the gel is manually applied to a substrate, the gel will maintain its shape for an amount of time sufficient to attach a second substrate to the first substrate. Gels are not always form stable, however, the gel can be made form stable by the addition of an extending filler to the curable silicone composition, by the use of a support, or a combination thereof. The gel may be a commercially available silicone gel, such as GT-1700 from Dow Corning Corporation of Newark, CA, USA.

Alternatively, the gel may be prepared from a curable silicone composition. The curable silicone composition may comprise: (A) a base polymer, optionally (B) a crosslinker, and an amount sufficient to accelerate curing of the composition of (C) a catalyst, where the ingredients and amounts are selected such that a cured product of the curable silicone composition is a gel.

### Hydrosilylation Curable Composition

The curable silicone composition used to form the gel described above may comprise a hydrosilylation curable composition. The hydrosilylation curable composition comprises (A′) a base polymer having an average of at least two aliphatically unsaturated organic groups per molecule, (B′) a crosslinker having an average of at least two silicon-bonded hydrogen atoms per molecule, and (C′) a hydrosilylation catalyst, where the ingredients and amounts are selected such that a product prepared by curing the composition is a gel.

### Ingredient (A′) Base Polymer

Ingredient (A′) of the hydrosilylation curable composition may comprise a polyorganosiloxane having an average of at least two aliphatically unsaturated organic groups per molecule. Ingredient (A′) may have a linear or branched structure. Alternatively, ingredient (A′) may have a linear structure. Ingredient (A′) may be a homopolymer or a copolymer. The aliphatically unsaturated organic groups may be alkenyl exemplified by, but not limited to, vinyl, allyl, butenyl, and hexenyl. The unsaturated organic groups may be alkynyl groups exemplified by, but not limited to, ethynyl, propynyl, and butynyl. The aliphatically unsaturated organic groups in ingredient (A′) may be located at terminal, pendant, or both terminal and pendant positions. Alternatively, the aliphatically unsaturated organic groups in ingredient (A′) may be located at terminal positions.

The remaining silicon-bonded organic groups in ingredient (A′) may be monovalent organic groups free of aliphatic unsaturation. These monovalent organic groups may have 1 to 20 carbon atoms, alternatively 1 to 10 carbon atoms, and are exemplified by, but not limited to hydrocarbon groups including alkyl groups such as methyl, ethyl, propyl, pentyl, octyl, undecyl, and octadecyl; cycloalkyl groups such as cyclopentyl and cyclohexyl; and aromatic groups such as phenyl, tolyl, xylyl, benzyl, and 2-phenylethyl.

Ingredient (A′) may comprise a polydiorganosiloxane of

R¹₂R²SiO(R¹₂SiO)ₐ(R¹R²SiO)_{b}SiR¹₂R², Formula (I)

R¹₃SiO(R¹₂SiO)_{c}(R¹R²SiO)_{d}SiR¹₃, Formula (II)

or a combination thereof.

In Formulae (I) and (II), each R¹ is independently a monovalent organic group free of aliphatic unsaturation and each R² is independently an aliphatically unsaturated organic group. The subscripts, a, b, c, and d have values sufficient to give the polydiorganosiloxane a viscosity ranging from 100 to 20,000 mPa·s as measured by Brookfield RVT CP-52 viscometer at 5 rpm.

Alternatively, subscript a may have an average value ranging from 2 to 2000, subscript b may have an average value ranging from 0 to 2000, subscript c may have an average value ranging from 0 to 2000, and subscript d may have an average value ranging from 2 to 2000. Suitable monovalent organic groups for R¹ include, but are not limited to, alkyl such as methyl, ethyl, propyl, pentyl, octyl, undecyl, and octadecyl; cycloalkyl such as cyclohexyl; and aryl such as phenyl, tolyl, xylyl, benzyl, and 2-phenylethyl. Each R² is independently an aliphatically unsaturated monovalent organic group. R² is exemplified by alkenyl groups such as vinyl, allyl, and butenyl and alkynyl groups such as ethynyl and propynyl.

Ingredient (A′) may comprise polydiorganosiloxanes such as
i) dimethylvinylsiloxy-terminated polydimethylsiloxane,
ii) dimethylvinylsiloxy-terminated poly(dimethylsiloxane/methylvinylsiloxane),
iii) dimethylvinylsiloxy-terminated polymethylvinylsiloxane,
iv) trimethylsiloxy-terminated poly(dimethylsiloxane/methylvinylsiloxane),
v) trimethylsiloxy-terminated polymethylvinylsiloxane,
vi) dimethylvinylsiloxy-terminated poly(dimethylsiloxane/methylphenylsiloxane),
vii) dimethylvinylsiloxy-terminated poly(dimethylsiloxane/diphenylsiloxane),
viii) phenyl,methyl,vinyl-siloxy-terminated polydimethylsiloxane,
ix) dimethylhexenylsiloxy-terminated polydimethylsiloxane,
x) dimethylhexenylsiloxy-terminated poly(dimethylsiloxane/methylhexenylsiloxane),
xi) dimethylhexenylsiloxy-terminated polymethylhexenylsiloxane,
xii) trimethylsiloxy-terminated poly(dimethylsiloxane/methylhexenylsiloxane),
xiii) a combination thereof.

Methods of preparing polydiorganosiloxane fluids suitable for use as ingredient (A′), such as hydrolysis and condensation of the corresponding organohalosilanes or equilibration of cyclic polydiorganosiloxanes, are well known in the art.

Ingredient (A′) can be a single base polymer or a combination comprising two or more base polymers that differ in at least one of the following properties: structure, viscosity, average molecular weight, siloxane units, and sequence.

### Ingredient (B′) Crosslinker

Ingredient (B′) in the hydrosilylation curable composition is a crosslinker having an average of at least two silicon-bonded hydrogen atoms per molecule. The amount of ingredient (B′) in the hydrosilylation cure package is sufficient to crosslink the composition to form a gel, as described above. The amount of ingredient (B′) will vary depending on the structure and vinyl content of ingredient (A′) and the structure and SiH content of ingredient (B′), however, the amount may range from 0.5 part to 15 parts, alternatively 1 part to 5 parts, per 100 parts by weight of ingredient (A′). Ingredient (B′) can be a homopolymer or a copolymer. Ingredient (B′) can have a linear, branched, or cyclic structure. The silicon-bonded hydrogen atoms in ingredient (B′) can be located at terminal, pendant, or at both terminal and pendant positions.

Ingredient (B′) may comprise siloxane units including, but not limited to, HR³₂SiO_{1/2}, R³₃SiO_{1/2}, HR³SiO_{2/2}, R³₂SiO_{2/2}, R³SiO_{3/2}, and SiO_{4/2} units. In the preceding formulae, each R³ is independently selected from monovalent organic groups, such as those described above.

Ingredient (B′) may comprise a polydiorganohydrogensiloxane of the formula

R⁴₃SiO(R⁴₂SiO)ₑ(R⁴HSiO)_{f}SiR⁴₃, (VI)

R⁴₂HSiO(R⁴₂SiO)_{g}(R⁴HSiO)ₕSiR⁴₂H, or (VII)

(VIII) a combination thereof.

In the formulae above, the subscripts, e, f, g, and h have values sufficient to give the polydiorganohydrogensiloxane a viscosity ranging from 10 mPa·s to 500 mPa·s. Alternatively, subscript e may have an average value ranging from 0 to 2000, subscript f may have an average value ranging from 2 to 2000, subscript g may have an average value ranging from 0 to 2000, and subscript h may have an average value ranging from 0 to 2000. Each R⁴ is independently a monovalent organic group. Suitable monovalent organic groups include alkyl such as methyl, ethyl, propyl, pentyl, octyl, undecyl, and octadecyl; cycloalkyl such as cyclohexyl; alkenyl such as vinyl, allyl, butenyl, and hexenyl; alkynyl such as ethynyl, propynyl, and butynyl; and aryl such as phenyl, tolyl, xylyl, benzyl, and 2-phenylethyl.

Ingredient (B′) is exemplified by
a) dimethylhydrogensiloxy-terminated polydimethylsiloxane,
b) dimethylhydrogensiloxy-terminated poly(dimethylsiloxane/methylhydrogensiloxane),
c) dimethylhydrogensiloxy-terminated polymethylhydrogensiloxane,
d) trimethylsiloxy-terminated poly(dimethylsiloxane/methylhydrogensiloxane),
e) trimethylsiloxy-terminated polymethylhydrogensiloxane, and
f) a combination thereof.

Ingredient (B′) may be a combination of two or more SiH functional crosslinkers that differ in at least one of the following properties: structure, average molecular weight, viscosity, siloxane units, and sequence. Methods of preparing linear, branched, and cyclic organohydrogenpolysiloxanes suitable for use as ingredient (B′), such as hydrolysis and condensation of organohalosilanes, are well known in the art. Methods of preparing organohydrogenpolysiloxane resins suitable for use as ingredient (B′) are also well known as exemplified in U.S. Pat. Nos. 5,310,843; 4,370,358; and 4,707,531.

### Ingredient (C′) Hydrosilylation Catalyst

Ingredient (C′) of the hydrosilylation curable composition is a hydrosilylation catalyst. Ingredient (C′) is added in an amount ranging from 0.1 ppm to 1000 ppm of platinum group metal, alternatively 1 ppm to 500 ppm, alternatively 2 ppm to 200 ppm, and alternatively 5 ppm to 150 ppm, based on the weight of the hydrosilylation curable composition.

Suitable hydrosilylation catalysts are known in the art and are commercially available. Ingredient (C′) may comprise a platinum group metal selected from platinum, rhodium, ruthenium, palladium, osmium or iridium metal or organometallic compound thereof, or a combination thereof. Ingredient (C′) is exemplified by compounds such as chloroplatinic acid, chloroplatinic acid hexahydrate, platinum dichloride, and complexes of said compounds with low molecular weight organopolysiloxanes or platinum compounds microencapsulated in a matrix or coreshell type structure. Complexes of platinum with low molecular weight organopolysiloxanes include 1,3-diethenyl-1,1,3,3-tetramethyldisiloxane complexes with platinum. These complexes may be microencapsulated in a resin matrix. When the catalyst is a platinum complex with a low molecular weight organopolysiloxane, the amount of catalyst may range from 0.01% to 0.4% based on the weight of the hydrosilylation curable composition.

Suitable hydrosilylation catalysts for ingredient (C′) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and EP 0 347 895 B. Microencapsulated hydrosilylation catalysts and methods of preparing them are known in the art, as exemplified in U.S. Pat. Nos. 4,766,176 and 5,017,654.

### Peroxide Cure Packages

Alternatively, the curable silicone composition may comprise a peroxide curable composition. The peroxide curable composition may comprise (A″) a base polymer having an average of at least two aliphatically unsaturated organic groups per molecule, optionally (B″) a crosslinkers, and (C″) a catalyst, where the ingredients and amounts are selected such that a cured product of the composition is a gel.

### Ingredient (A″) Base Polymer

Ingredient (A″) of the peroxide cure package comprises a polydiorganosiloxane having an average of at least two aliphatically unsaturated organic groups per molecule. Ingredient (A″) may be a homopolymer or a copolymer. The aliphatically unsaturated organic groups may be alkenyl exemplified by, but not limited to, vinyl, allyl, butenyl, and hexenyl. The aliphatically unsaturated organic groups may be alkynyl groups exemplified by, but not limited to, ethynyl, propynyl, and butynyl. The unsaturated organic groups in ingredient (A″) may be located at terminal, pendant, or both terminal and pendant positions. Alternatively, the aliphatically unsaturated organic groups in ingredient (A″) may be located at terminal positions.

The remaining silicon-bonded organic groups in ingredient (A′″) may be monovalent organic groups free of aliphatic unsaturation. These monovalent organic groups are exemplified by, but not limited to alkyl groups such as methyl, ethyl, propyl, pentyl, octyl, undecyl, and octadecyl; cycloalkyl groups such as cyclohexyl; and aromatic groups such as phenyl, tolyl, xylyl, benzyl, and 2-phenylethyl.

Ingredient (A″) may comprise a polydiorganosiloxane of

R⁵₂R⁶SiO(R⁵₂SiO)ᵢ(R⁵R⁶SiO)ⱼSiR⁵₂R⁶, Formula (IX)

R⁵₃SiO(R⁵₂SiO)ₖ(R⁵R⁶SiO)ₘSiR⁵₃, Formula (X)

or a combination thereof.

In formulae (IX) and (X), each R⁵ is independently a monovalent organic group free of aliphatic unsaturation, and each R⁶ is independently an aliphatically unsaturated organic group. In formulae above, the subscripts, i, j, k, and m have values sufficient to give the polydiorganohydrogensiloxane a viscosity ranging from 100 mPa·s to 15,000 mPa·s. Alternatively, subscript i may have an average value of at least 2, subscript j may be 0 or a positive number, subscript k may be 0 or a positive number, and subscript m has an average value of at least 2. Suitable monovalent organic groups for R⁵ include, but are not limited to, alkyl such as methyl, ethyl, propyl, pentyl, octyl, undecyl, and octadecyl; cycloalkyl such as cyclohexyl; and aryl such as phenyl, tolyl, xylyl, benzyl, and 2-phenylethyl. Each R⁶ is independently an aliphatically unsaturated monovalent organic group. R⁶ is exemplified by alkenyl groups such as vinyl, allyl, and butenyl and alkynyl groups such as ethynyl and propynyl.

Methods of preparing polydiorganosiloxane fluids suitable for use as ingredient (A″), such as hydrolysis and condensation of the corresponding organohalosilanes or equilibration of cyclic polydiorganosiloxanes, are well known in the art. Ingredient (A″) may be a combination of two or more polydiorganosiloxanes that differ in at least one of the following properties: structure, average molecular weight, viscosity, siloxane units, and sequence.

### Optional Ingredient (B″) Crosslinker

Ingredient (B″) is a crosslinker may optionally be added to the peroxide curable composition. The amount of ingredient (B″) in the composition may range from 0 to 15 parts per 100 parts by weight of ingredient (A″). Ingredient (B″) may comprise a polydiorganohydrogensiloxane having an average of at least two silicon-bonded hydrogen atoms per molecule.

Ingredient (B″) may comprise a polydiorganohydrogensiloxane of the formula

R⁷₃SiO(R⁷₂SiO)ₙ(R⁷HSiO)ₒSiR⁷₃, (XI)

R⁷₂HSiO(R⁷₂SiO)ₚ(R⁷HSiO)_{q}SiR⁷₂H, or (XII)

(XIII) a combination thereof.

In the formulae above, the subscripts, n, o, p, and q have values sufficient to give the polydiorganohydrogensiloxane a viscosity ranging from 10 mPa·s to 500 mPa·s. Alternatively, subscript n may have an average value ranging from 0 to 2000, subscript o may have an average value ranging from 2 to 2000, subscript p may have an average value ranging from 0 to 2000, and subscript q has an average value ranging from 0 to 2000, with the provisos that (n+o)<2000 and (p+q)<2000. Each R⁷ is independently a monovalent organic group. Suitable monovalent organic groups include alkyl such as methyl, ethyl, propyl, pentyl, octyl, undecyl, and octadecyl; cycloalkyl such as cyclohexyl; alkenyl such as vinyl, allyl, butenyl, and hexenyl; alkynyl such as ethynyl, propynyl, and butynyl; and aryl such as phenyl, tolyl, xylyl, benzyl, and 2-phenylethyl.

Ingredient (B″) is exemplified by
i) dimethylhydrogensiloxy-terminated polydimethylsiloxane,
ii) dimethylhydrogensiloxy-terminated poly(dimethylsiloxane/methylhydrogensiloxane),
iii) dimethylhydrogensiloxy-terminated polymethylhydrogensiloxane,
iv) trimethylsiloxy-terminated poly(dimethylsiloxane/methylhydrogensiloxane),
v) trimethylsiloxy-terminated polymethylhydrogensiloxane,
vi) a combination thereof.

Methods of preparing linear, branched, and cyclic organohydrogenpolysiloxanes suitable for use as ingredient (B′), such as hydrolysis and condensation of organohalosilanes, are well known in the art. Ingredient (B″) may be a combination of two or more polydiorganohydrogensiloxanes that differ in at least one of the following properties: structure, average molecular weight, viscosity, siloxane units, and sequence.

### Ingredient (C″) Catalyst

Ingredient (C″) in the peroxide curable composition comprises a peroxide compound. The amount of ingredient (C″) added to the composition depends on the specific peroxide compound selected for ingredient (C″), however, the amount may range from 0.2 to 5 parts per 100 parts by weight of ingredient (A″). Examples of peroxide compounds suitable for ingredient (C″) include, but are not limited to 2,4-dichlorobenzoyl peroxide, dicumyl peroxide, and a combination thereof; as well as combinations of such a peroxide with a benzoate compound such as tertiary-butyl perbenzoate. Suitable peroxide curable composition are known in the art, and are disclosed in, for example, U.S. Pat. No. 4,774,281.

### Optional Ingredients

The curable silicone composition may further comprise one or more additional ingredients in addition to ingredients (A), (B), and (C) described above. The composition may further comprise an additional ingredient selected from the group consisting of (D) an extending filler, (E) a filler treating agent, (F) a stabilizer (e.g., a hydrosilylation cure stabilizer, a heat stabilizer, or a UV stabilizer), (G) a plasticizer, (H), a chain extender, (I) an adhesion promoter, (J) a fungicide, (K) a rheological additive, (L) a flame retardant, (M) a pigment, and a combination thereof.

### Optional Ingredient (D) Extending Filler

The curable silicone composition may optionally further comprise ingredient (D) an extending filler. The amount of extending filler depends on various factors including the type and amount of extending filler, filler treating agent (if any), and the amount of tack desired in the form stable gel. In general, as the amount of extending filler increases, the tack of the form stable gel decreases. The amount of tack desired depends on various factors including customer requirements, however, when the form stable gel will be used in aluminum window frame applications, the amount of tack should be sufficient to allow the form stable gel to stick to a substrate during the method to attach a second substrate thereto. However, when present, the extending filler may be present in an amount ranging from 20% to 90%, alternatively 40% to 70%, alternatively 45% to 70%, and alternatively 45% to 55%, based on the weight of the curable composition.

Examples of extending fillers include barium sulfate, bentonite, carbon black, clays such as kaolin clay, crushed quartz, diatomaceous earth, graphite, ground calcium carbonate, ground silica, iron oxide, magnesium oxide, sand, talc, titanium dioxide, zinc oxide, zirconia, or a combination thereof. Alternatively, the extending filler may be selected from the group consisting of barium sulfate, bentonite, diatomaceous earth, ground calcium carbonate, kaolin clay, and a combination thereof. Extending fillers are known in the art and commercially available; such as a ground silica sold under the name MIN-U-SIL by U.S. Silica of Berkeley Springs, W. Va. When ground calcium carbonate is used as ingredient (D), the amount of ground calcium carbonate may range from 20% to 80%, alternatively 45% to 55%, based on the weight of the curable silicone composition.

The extending filler may be added to the curable silicone composition to reduce cost of the gel, to control tack of the gel, or both. The extending filler should be selected such that a sufficient amount of extending filler can be added to the curable silicone composition without forming a paste. Precipitated calcium carbonate is not preferred. Without wishing to be bound by theory, it is thought that precipitated calcium carbonate may contain water in an amount that causes formation of a paste when sufficient amounts of such filler to reduce tack are added to the curable silicone composition, and even treated precipitated calcium carbonate may cause formation of the paste. One skilled in the art would be able to select a suitable extending filler without undue experimentation.

### Optional Ingredient (E) Filler Treating Agent

The curable silicone composition may optionally further comprise ingredient (E), a filler treating agent in an amount ranging from 0.1% to 15%, alternatively 0.5% to 5%, based on the weight of the composition. Ingredient (D), may optionally be surface treated with ingredient (E) before being added to the composition or in situ. Ingredient (E) may comprise an alkoxysilane, an alkoxy-functional oligosiloxane, a cyclic polyorganosiloxane, a hydroxyl-functional oligosiloxane such as a dimethyl siloxane or methyl phenyl siloxane, or a fatty acid such as stearic acid. Examples of stearates include calcium stearate. Examples of filler treating agents and methods for their use are disclosed in, for example, EP 1 101 167 A2 and U.S. Pat. Nos. 5,051,455; 5,053,442; and 6,169,142 (col. 4, line 42 to col. 5, line 2).

### Optional Ingredient (F) Stabilizer

Ingredient (F) is a stabilizer. Stabilizers for hydrosilylation curable compositions are exemplified by acetylenic alcohols such as methyl butynol, ethynyl cyclohexanol, dimethyl hexynol, and 3,5-dimethyl-1-hexyn-3-ol, 1,1-dimethyl-2-propynyl)oxy)trimethylsilane, methyl(tris(1,1-dimethyl-2-propynyloxy))silane, and a combination thereof; cycloalkenylsiloxanes such as methylvinylcyclosiloxanes exemplified by 1,3,5,7-tetramethyl-1,3,5,7-tetravinylcyclotetrasiloxane, 1,3,5,7-tetramethyl-1,3,5,7-tetrahexenylcyclotetrasiloxane, and a combination thereof; ene-yne compounds such as 3-methyl-3-penten-1-yne, 3,5-dimethyl-3-hexen-1-yne; triazoles such as benzotriazole; phosphines; mercaptans; hydrazines; amines such as tetramethyl ethylenediamine, dialkyl fumarates, dialkenyl fumarates, dialkoxyalkyl fumarates, maleates such as diallyl maleate, and a combination thereof. Alternatively, the stabilizer may comprise an acetylenic alcohol. Suitable hydrosilylation cure package stabilizers are disclosed by, for example, U.S. Pat. Nos. 3,445,420; 3,989,667; 4,584,361; and 5,036,117.

The amount of stabilizer added to the curable silicone composition will depend on the particular stabilizer used and the composition and amount of crosslinker. However, the amount of hydrosilylation cure stabilizer may range from 0.0025% to 0.025% based on the weight of the hydrosilylation curable composition.

### Optional Ingredient (G) Plasticizer

The plasticizer may optionally be added to the curable silicone composition to improve rheological properties. The plasticizer may be a nonfunctional polyorganosiloxane, such as polydimethylsiloxane having a viscosity ranging from 0.5 cSt to 20 cSt. Suitable plasticizers are commercially available as DOW CORNING® 200 Fluids from Dow Corning Corporation of Midland, Mich., USA.

### Optional Ingredient (H) Chain Extender

The chain extender may optionally be added to the curable silicone composition to improve physical properties of the gel formed by curing the curable silicone composition. The chain extender may be a polydiorganosiloxane terminated with dimethyhydrogensiloxy groups. The chain extender may have a degree of polymerization (Dp) ranging from 3 to 100, alternatively 3 to 10. The amount of chain extender is added in addition to the crosslinker, and may range from 0 to 5% of the curable silicone composition, alternatively 0.25% to 2.5%.

One skilled in the art would recognize that the curable silicone composition may comprise more than one cure mechanism. For example a dual cure composition that is both radiation curable and hydrosilylation curable is within the scope of this invention. One skilled in the art would be able to select ingredients and amounts thereof in each curable silicone composition described above to prepare a cured product that has a desired consistency as a gel.

### Method of Making the Curable Silicone Composition

The curable silicone composition may be prepared as a one part composition, for example, by combining all ingredients by any convenient means, such as mixing. Alternatively, the curable silicone composition may be prepared as a multiple part composition in which the crosslinker and catalyst are stored in separate parts, and the parts are combined shortly before use of the curable silicone composition. For example, a two part curable silicone composition may be prepared by combining ingredients comprising (A), (C), and any optional ingredients in a base part by any convenient means such as mixing. A curing agent part may be prepared by combining ingredients comprising (A), (B), and any optional ingredients by any convenient means such as mixing. Ingredient (D) may be added to the base part, the curing agent part, or both. The ingredients may be combined at ambient or elevated temperature, depending on the cure mechanism selected. When a two part curable silicone composition is used, the ratio of amounts of base to curing agent may range from 1:1 to 10:1. One skilled in the art would be able to prepare a curable silicone composition without undue experimentation.

### Support

A support may be used to help impart form stability to the gel described above. The support may be a foam or mesh, such as silicone foam, or cotton, fiberglass, or metal mesh.

Suitable meshes are known in the art and are commercially available. Cotton mesh is exemplified by cheesecloth. BGF Industries, Inc., of Greensboro, N.C., USA manufactures various grades of fiberglass mesh, exemplified by those in Table 1, below in which LOI % means Loss of ingredients.

TABLE 1
Fiberglass Mesh

| Style/Finish | Average Thickness (inch) | Finish by Weight (LOI %) |
|---|---|---|
| 1084/A57C | 0.0025″ (.06 mm) | 2.20% |
| 1080/642 | 0.0022″ (.05 mm) | 0.22% |
| 2112/642 | 0.0032″ (.08 mm) | 0.14% |
| 2116/642 | 0.0036″ (.09 mm) | 0.11% |

The form stable gel may have a release liner on its surface, for example, to protect the gel after manufacture and before use. The release liner is not critical and may be any commercially available release liner capable of protecting the surface of the gel. Examples of suitable release liners include silicone coated release paper, plastic sheets such as polyester such as MYLAR® from LOPAREX, printed release paper from XPEDX, MATTE-FINISH-POLY-21-INCH marketed under the tradename FILCON from The Dow Chemical Company of Midland, Mich., USA; and OS-GEL-1084-A57C-TB-20W (a fiberglass) available from BGF Industries, Inc., of Greensboro, N.C., USA.

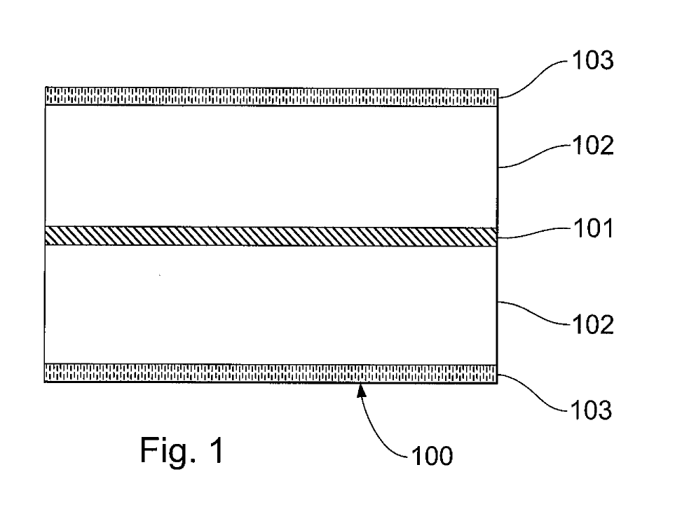

FIG. 1 shows an example of a form stable gel 100 useful as described herein. The form stable gel 100 has a support 101 with layers of gel 102 disposed on opposing sides of the support 101. The layers of gel 102 have release liners 103 protecting their surfaces. The release liners 103 may be removed shortly before contact of the form stable gel 100 with a substrate.

The form stable gel, with or without a support (and without release liners) has a thickness sufficient to form a seal between substrates. The thickness depends on various factors including the substrate materials of construction, the surface roughness, and the material to be sealed against (e.g., gas penetration such as air, vapor penetration such as moisture, or both). However, the form stable gel 100 may have a thickness ranging from 0.25 mm to 6 mm, alternatively 0.5 mm to 1.5 mm. When the form stable gel will be used to seal an aluminum window frame, the form stable gel may have sufficient resistance to water penetration to pass the test of preventing leakage when 3 inches of water are sealed by the form stable gel for at least 18 minutes.

The form stable gel may have a hardness ranging from 30 to 70 on a Shore 00 scale. The form stable gel may have a tack of at least 30 grams as measured with a texture analyzer having a probe descending onto the form stable gel and depressing 2 mm at a speed of 0.2 mm/sec, and thereafter measuring the force to lift the probe off the gel, as described in Reference Example 1, below. Alternatively, tack may range from 30 grams to 200 grams, as measured by the method described in Reference Example 1.

### Method

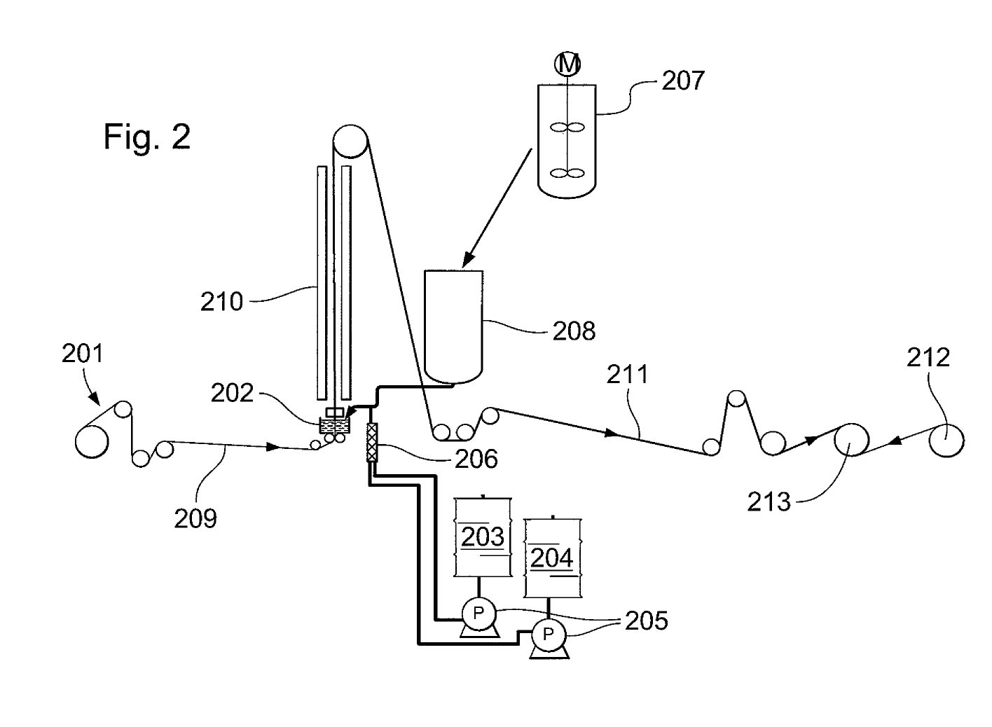

A method for making the form stable gel is exemplified in FIG. 2. Fiberglass mesh is fed from payoff 201 to primary coater 202. The curable silicone composition is prepared by mixing, for example, a base part and a curing agent part as described above. The base may be stored in a drum 203 and the curing agent may be stored in another drum 204, and the base and curing agent may be pumped with drum pumps 205 to a static mixer 206. Alternatively, the curable silicone composition may be prepared in a mixer 207 and fed to a storage tank 208.

The curable silicone composition may be supplied to primary coater 202, which coats one side of the fiberglass mesh 209. The coated mesh 209 is then fed through a primary heater 210 to cure the curable silicone composition and form the form stable gel 211. The resulting form stable gel 211 can have a release liner (such as the polyester, matte finish paper, or polyethylene described above) put on its surface by feed roll 212. The resulting form stable gel 211 having the release liners on its surface is collected on a roll at product take up 213.

One skilled in the art would recognize that the method described above is exemplary and not limiting. For example, a different type of coater may be used to coat the curable silicone composition on the substrate. Alternatively, more than one coater may be used in series, for example, when the thickness of the gel layer 102 is greater than 1.5 mm.

### Methods of Use

The form stable gel described above may be used to provide a seal between a first substrate and a second substrate. The method for using the form stable gel comprises i) applying the form stable gel described above to a first substrate, and ii) connecting the first substrate and a second substrate with the form stable gel between the substrates. The method may optionally further comprise iii) shaping the form stable gel to conform to the substrates, e.g., by trimming the form stable gel after step ii), or by die cutting the form stable gel before step i).

The substrates may be any substrates commonly used in the construction industry, such as wood, metal (e.g., aluminum or steel), glass, fiberglass, plastic (e.g., extruded polyvinylchloride), or combinations thereof. For example, in one application, the form stable gel may be used to provide a seal that prevents moisture from entering two members of a window frame. The first substrate may be a frame member, such as an aluminum mullion, and the second substrate may be a second aluminum fame member. The mullion may be fastened to the frame member with fasteners such screws or bolts. The form stable gel forms a seal between the mullion and the frame member even after the fasteners pass through the gel.

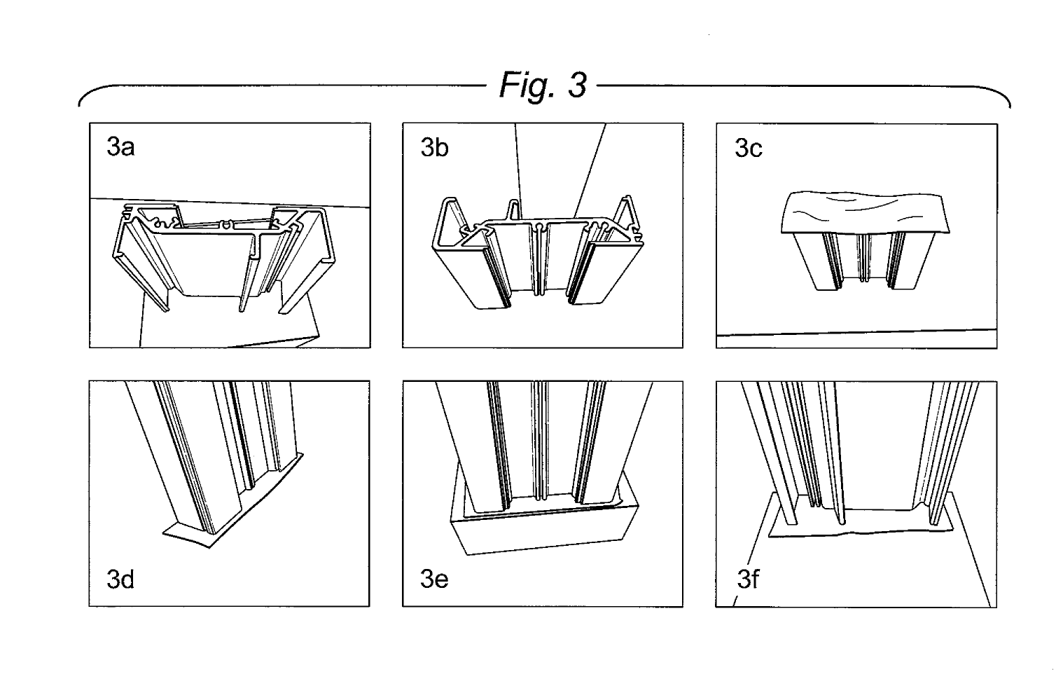

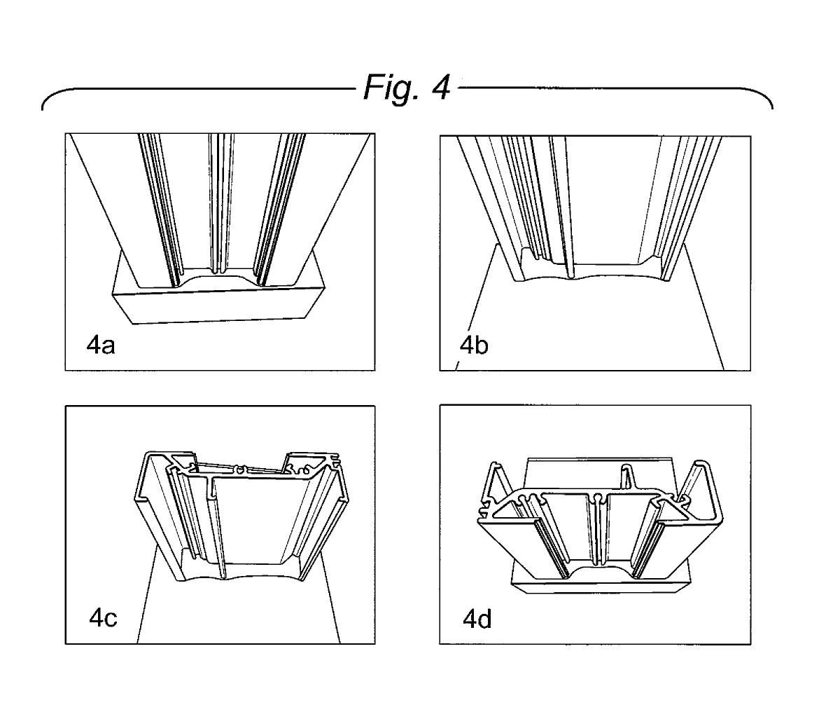

A method for using the form stable gel is exemplified in FIGS. 3 and 4. In FIG. 3, an aluminum mullion 3a with irregular shape and a strip of form stable gel 3b are provided. The form stable gel 3b is manually applied to the end of the aluminum mullion 3c. The form stable gel adheres to the end of the mullion when it is moved 3d. The aluminum mullion is fastened to an aluminum frame member with screws 3e (front view), 3f (back view). FIG. 4 shows the step of trimming the form stable gel. The excess form stable gel can be removed by manually cutting with a knife Alternatively, the form stable gel could be precut by a die cutter into the shape of the mullion for a more precise fit.

Alternatively, the form stable gel may be used for sealing in replacement window applications and retrofit window applications. For example, to install a replacement window, a method comprises i) removing the old window and ii) sliding a new window into the space left by the old window from the outside. The form stable gel may be applied to the wall around the space or to the frame around the new window before step ii). The method further comprises fastening the new window in place, for example, by installing screws from the inside.

Alternatively, the form stable gel may be used for sealing a bathroom or kitchen fixture to a mounting. At least one of the first substrate and the second substrate may be a fixture selected from the group consisting of a shower enclosure, bathtub, and a sink. For example, the form stable gel may be applied to a sink (e.g., kitchen or bathroom sink), and the sink may then be mounted to a cabinet.

Alternatively, the form stable gel may be used for sealing applications in boats. One of the first substrate and the second substrate may be a boat hull. The other of the first substrate and the second substrate may be boat window or a pipe, such a septic tank line.

### EXAMPLES

The following examples are included to demonstrate the invention to those of ordinary skill in the art. However, those of skill in the art should, in light of the present disclosure, appreciate that many changes can be made in the specific embodiments which are disclosed and still obtain a like or similar result without departing from the spirit and scope of the invention set forth in the claims. All amounts, ratios, and percentages are by weight unless otherwise indicated.

The following ingredients were used in the examples.

Base Polymer (A1) was dimethylvinylsiloxy-terminated polydimethylsiloxane having a viscosity of 5,000 mPa·s (using a Brookfield RVT CP-52 viscometer at 5 rpm) and a vinyl content ranging from 0.15% to 0.19% (measured using infra red techniques).

Crosslinker (B1) was a trimethylsiloxy-terminated poly(dimethylsiloxane/methylhydrogensiloxane) polymer having a viscosity ranging from 141 cSt to 172 cSt using the standard capillary method, SiH content ranging from 0.112% to 0.118% using Infra red techniques.

Catalyst (C1) was a mixture of 5.5% of 1,3-diethenyl-1,1,3,3-tetramethyldisiloxane complex of platinum in a dimethylvinylsiloxy-terminated polydimethylsiloxane, having a viscosity ranging from 300 to 700 cP (300 to 700 mPa·s) and an amount of platinum metal ranging from 2.2% to 2.4%.

Chain Extender (1) was a hydrogen terminated polydimethylsiloxane having a viscosity ranging from 9 to 13 cSt using the standard capillary method and SiH content ranging from 0.112% to 0.119% using Infra red techniques.

Stabilizer (1) was 3,5-dimethyl-1-hexyn-3-ol, commercially available from Sigma-Aldrich of Milwaukee, Wis., 53201, USA.

Calcium Carbonate (D1) was Hubercarb Q from Huber Engineered Materials, part of J. M. Huber Corporation, of Quincy, Ill., 62305-9378, USA. This ground calcium carbonate was treated with 0.75% to 1.5% stearic acid.

### Example 1

A two part curable silicone composition was prepared. First, the Calcium Carbonate (D1) was dried by heating for 4 hours in an oven at 150° C. The base was prepared by mixing 9 weight parts Base Polymer (A1) and 0.008 weight parts Catalyst (C1) in a 5 gallon (18.925 litre) pail for 5 minutes. Calcium Carbonate (D1) in an amount of 11 weight parts was added and mixed for 5 minutes or until smooth.

The curing agent was prepared by mixing 8.25 weight parts Base Polymer (A1), 0.24 weight parts Crosslinker (B1), 0.5 weight parts Chain Extender (1) and 0.008 weight parts Stabilizer (1) in a 5 gallon (18.925 litre) pail for 3 minutes. Calcium Carbonate (D1) in an amount of 11 weight parts was added and mixed for 5 minutes or until smooth.

The base and curing agent were combined and the resulting curable silicone composition was applied to opposing sides of a fiberglass mesh (1084/A57C), which is available from BGF Industries, Inc. of Greensboro, N.C., USA). The curable silicone composition was cured by heating at 125° C. for 30 minutes. The apparatus in FIG. 2 was used to prepare the form stable gel in this example.

The fiberglass payoff 201 operated with a centered spindle position and a payoff tension of 0 to 15 psi (0 to 1.05 kgcm⁻²). The fiberglass 209 roll length was 1000 m, and the weight was 55 kg. The primary coater 202 and primary heater 210 operated at a startup temperature ranging from 240° F. to 260° F. (115.56 to 126.67° C.) and a run temperature ranging from 260° F. to 360° F. (126.67 to 182.2° C.). The drive speed was 1 to 8 feet per minute (fpm) (0.305 to 2.44 metres per minute), and the thickness of the curable silicone composition applied to the fiberglass was controlled by the blade gap of the coater blade from the fiberglass. The secondary coater 211 and secondary heater 212 operated at a startup temperature ranging from 260° F. to 280° F. (126.67 to 137.8° C.) and a run temperature ranging from 260° F. to 360° F. (126.67 to 342.2° C.). The drive speed was 1 to 8 fpm (0.305 to 2.44 metres per minute). The thickness was controlled by the roll gap.

The product take up 214 was operated with a centered spindle position. The take up tension ranged from 20 to 40 psi (1.4 to 2.8 kgcm⁻²) and the pay off tension ranged from 5 to 15 psi (0.35 to 1.05 kgcm⁻²). The form stable gel product roll weight ranged from 25 to 35 kg and its length varied.

### Example 2

### Performance

A sample of the form stable gel prepared in example 1 was placed against a vertical aluminum frame member. A horizontal aluminum frame member was fastened to the vertical aluminum frame member with screws. The vertical aluminum frame member was hollow and filled with 18 inches (45.72 cm) of water. The frame had no visible leaks after 3 months, which exceeded the industry standard measurement of 3 inches (7.62 cm) of water with no leaks after 18 minutes.

### Reference Example 1

### Tack Measurement

A strip of form stable gel with dimensions of 1 inches by 6 inches (15.24 cm) was prepared using the coating apparatus in FIG. 2. The strip was placed between plastic plates with holes through the centers, thereby exposing a 1 inch (2.54 cm) diameter stretched membrane of form stable gel secured at its edges. A TA-XT2 Texture Analyzer was used to measure tack. The probe was descended onto the gel and depressed 2 mm at a speed of 0.2 mm/sec, and tack was recorded by measuring the force to lift the probe off the gel.

### Reference Example 2

### Hardness Measurement

Gel samples (9 mL) were prepared by mixing equal weights of base and curing agent, subjecting the mixture to vacuum for 2 to 5 minutes or until bubbles disappeared, cured in an oven at 125° C. for 30 minutes, and then cooled for 10 minutes.

A Texture analyzer with a ¼ inch (0.635 cm) steel ball probe attached thereto was used for the test. The ball probe was cleaned with isopropanol and wiped with a kimwipe. The hardness was measured by indentation of the sample with the ball probe. The probe indentation distance was 0.4 mm at a speed of 0.2 mm/s.

### INDUSTRIAL APPLICABILITY

The form stable gel described herein combines two effects to create a seal. First, under compression gels can conform around a variety of objects or irregular surfaces, so that the gel is in contact with the entire surface of the object to be sealed. Once the surfaces of the objects are in contact, the system dynamics may favor the coating of the surface by the gel versus by gas such as air or liquid or vapor such as water. This combination of conformability and surface wetting by the gel allows the form stable gel to seal against air and water. For purposes of this application, sealing against water means that a seal prepared with the form stable gel described herein passes the water penetration test of ASTM Standard E331. The form stable gel is self supporting enough and self adhesive enough to remain in place during assembly of a frame (or other substrates). The form stable gel does not leave residue when trimmed, as a conventional foam tape can. The form stable gel is therefore useful in a variety of applications in the construction industry.

1. A method comprising:
i) applying a form stable gel to a first substrate, where the form stable gel comprises a reaction product of a curable silicone composition and has a sufficient tack to adhere when applied to the first substrate until a second substrate is fastened thereto, and
ii) connecting the first substrate and the second substrate;
iii) thereby forming a seal between the first substrate and the second substrate.

2. The method of claim 1, where the composition comprises:
(A′) a polydiorganosiloxane having an average of at least two aliphatically unsaturated organic groups per molecule,
(B′) a crosslinker having an average of at least two silicon-bonded hydrogen atoms per molecule, and
(C′) a hydrosilylation catalyst.

3. The method of claim 1, where the composition comprises:
(A′) a polydiorganosiloxane having an average of at least two aliphatically unsaturated organic groups per molecule, optionally
(B′) a crosslinker, and
(C′) a peroxide catalyst.

4. The method of claim 1, where the composition further comprises an additional ingredient selected from the group consisting of: (D) an extending filler, (E) a filler treating agent, (F) a stabilizer, (G) a plasticizer, (H), a chain extender, (I) an adhesion promoter, (J) a fungicide, (K) a rheological additive, (L) a flame retardant, (M) a pigment, and a combination thereof.

5. The method of claim 4, where ingredient (D) is present in an amount ranging from 20 parts by weight to 90 parts by weight, based on 100 parts by weight of the composition.

6. The method of claim 5, where ingredient (D) is selected from the group consisting of kaolin clay, ground calcium carbonate, barium sulfate, bentonite, diatomaceous earth, talc, and combinations thereof.

7. The method of claim 1, where the form stable gel has a hardness ranging from 30 to 70 on a Shore 00 scale.

8. The method of claim 1, where the form stable gel has a tack of at least 30 grams as measured with a texture analyzer having a probe descending onto the form stable gel and depressing 2 mm at a speed of 0.2 mm/sec, and thereafter measuring the force to lift the probe off the gel.

9. The method of claim 1, where the composition is applied to a support and cured before step i) to form the form stable gel.

10. The method of claim 9, where the support is selected from the group consisting of a foam, rubber, or mesh.

11. (canceled)

12. The method of claim 9, where the composition is applied to two sides of a support and cured before step i).

13. The method of claim 9, where the composition is applied to a vertical support and cured before step i).

14. The method of claim 1, where the form stable gel has a thickness ranging from 0.25 mm to 6 mm.

15. The method of claim 1, where the first substrate is a first part of a window frame and the second substrate is a second part of the window frame.

16. The method of claim 1, where one of the first substrate and the second substrate is a fixture selected from the group consisting of a shower stall, a bathtub, and a sink.

17. The method of claim 1, where one of the first substrate and the second substrate is a wall and the other of the first substrate and the second substrate is a window frame.

18. (canceled)

19. An article comprising:
i) a first substrate,
ii) a second substrate mounted to the first substrate, and
iii) a form stable gel interposed between the first substrate and the second substrate, where the form stable gel forms a seal between the first substrate and the second substrate, and
where the form stable gel comprises a reaction product of a curable silicone composition and has a sufficient tack to adhere when applied to the first substrate until a second substrate is fastened thereto.

20. The article of claim 19, where the composition comprises:
(A′) a polydiorganosiloxane having an average of at least two aliphatically unsaturated organic groups per molecule,
(B′) a crosslinker having an average of at least two silicon-bonded hydrogen atoms per molecule, and
(C′) a hydrosilylation catalyst.

21. The article of claim 19, where the composition comprises:
(A′) a polydiorganosiloxane having an average of at least two aliphatically unsaturated organic groups per molecule, optionally
(B′) a crosslinker, and
(C′) a peroxide catalyst.

22. The article of claim 19, where the composition further comprises an additional ingredient selected from the group consisting of: (D) an extending filler, (E) a filler treating agent, (F) a stabilizer, (G) a plasticizer, (H), a chain extender, (I) an adhesion promoter, (J) a fungicide, (K) a rheological additive, (L) a flame retardant, (M) a pigment, and a combination thereof.

23. The article of claim 19, where ingredient (D) is present in an amount ranging from 20 parts by weight to 90 parts by weight, based on 100 parts by weight of the composition.

24. The article of claim 23, where ingredient (D) is selected from the group consisting of kaolin clay, ground calcium carbonate, barium sulfate, bentonite, diatomaceous earth, talc, and combinations thereof.

25. The article of claim 19, where the form stable gel has a hardness ranging from 30 to 70 on a Shore 00 scale.

26. The article of claim 19, where the form stable gel has a tack of at least 30 grams as measured with a texture analyzer having a probe descending onto the form stable gel and depressing 2 mm at a speed of 0.2 mm/sec, and thereafter measuring the force to lift the probe off the gel.

27. The article of claim 19, where the composition is applied to a support and cured before step i) to form the form stable gel.

28. The article of claim 27, where the support is selected from the group consisting of a foam, rubber, or mesh.

29. (canceled)

30. The article of claim 27, where the composition is applied to two sides of a support and cured before step i).

31. The article of claim 27, where the composition is applied to a vertical support and cured before step i).

32. The article of claim 19, where the form stable gel has a thickness ranging from 0.25 mm to 6 mm.

33. The article of claim 19, where the first substrate is a first part of a window frame and the second substrate is a second part of the window frame.

34. The article of claim 19, where one of the first substrate and the second substrate is a fixture selected from the group consisting of a shower stall, a bathtub, and a sink.

35. The article of claim 19, where one of the first substrate and the second substrate is a wall and the other of the first substrate and the second substrate is a window frame.

36. The article of claim 19, where one of the first substrate and the second substrate is a boat hull.

37. The method of claim 1, where one of the first substrate and the second substrate is a boat hull.
